(19) United States
(12) Patent Application Publication
(10) Pub. No.: US 2022/0086967 A1
(43) Pub. Date: Mar. 17, 2022

(54) MICROWAVE APPLIANCE AND METHOD FOR OPERATING A MICROWAVE

(71) Applicant: BSH Hausgeräte GmbH, Munich (DE)

(72) Inventors: Markus Kuchler, Gstadt am Chiemsee (DE); Kerstin Rigorth, Mühldorf (DE); Sebastian Sterz, Großaitingen (DE)

(21) Appl. No.: 17/423,914

(22) PCT Filed: Jan. 23, 2020
(86) PCT No.: PCT/EP2020/051672

§ 371 Date: Jul. 19, 2021

(30) Foreign Application Priority Data
Feb. 1, 2019 (DE) 10 2019 201 330.9

(51) Int. Cl. H05B 6/68; H05B 6/64; H05B 6/72

(52) U.S. Cl. CPC H05B 6/687; H05B 6/725; H05B 6/6482; H05B 6/6455

(57) ABSTRACT

A microwave appliance includes a microwave facility which generates microwaves and introduces the microwaves into a cooking compartment and which is operable with at least two configurations to generate different field distributions of the microwaves in the cooking compartment. A temperature acquisition facility contactlessly acquires a heat distribution in the cooking compartment, and a data processing facility identifies a non-food to be cooked region in the cooking compartment from the acquired heat distribution. A control facility sets a current configuration of the microwave facility and operates the microwave facility The control facility selects or sets at least one of the configurations of the microwave facility with regard to reducing a power of the microwaves in the identified non-food to be cooked region.

The invention relates to a microwave appliance, having a microwave facility, which is configured for generating microwaves and for introducing the microwaves into a cooking compartment and which can be operated with at least two configurations which generate different field distributions of the microwaves in the cooking compartment, a temperature acquisition facility, which is configured for contactlessly acquiring a heat distribution in the cooking compartment, and a control facility, which is configured for setting a current configuration of the microwave facility and for operating the microwave facility. The invention also relates to a method for operating a microwave appliance, in which a cooking compartment of the microwave appliance is heated and a heat distribution in the cooking compartment is acquired in a contactless manner. The invention is particularly advantageously applicable to household appliances.

EP 0 781 072 A1 discloses a microwave oven with a number of IR sensor elements for obtaining temperature information from discrete acquisition regions within the cooking zone of the oven and for generating a two-dimensional temperature image of the cooking zone. On the basis of this temperature image, it is possible for necessary load parameters to be calculated, in order to control automatic heating procedures in the oven.

EP 2 930 433 A1 discloses an oven with a heated cavity for cooking a foodstuff, which comprises a three-dimensional scanning system, which is configured for acquiring information regarding the volume and/or the shape of a foodstuff positioned in the heated cavity.

US 2018/098381 A1 discloses a computer-implemented method for heating an item in a chamber of an electronic oven toward a target state. The method comprises the heating of the item with a set of energy generators on the chamber, while the electronic oven is in a respective set of configurations. The set of energy generators and the respective set of configurations define a respective set of variable energy distributions in the chamber. The method also comprises an acquisition of sensor data, which defines a respective set of responses of the item to a set of applications of energy. The method also comprises generating a plan for heating the item in the chamber. The plan is generated by a control system of the electronic oven and uses the sensor data.

DE 10 2016 122 557 A1 discloses a method for operating a cooking appliance as well as a cooking appliance. Food to be cooked is treated on a carrier for food to be cooked in a cooking compartment using a treatment facility. The treatment facility is controlled by a control facility as a function of a treatment program. In this context, in order to take into consideration an influence of the carrier for food to be cooked on the treatment of the food to be cooked, a characteristic variable for the carrier for food to be cooked is ascertained and made available to the control facility. To this end, high-frequency measurement radiation with a plurality of frequencies is emitted into the cooking compartment, received again and evaluated. On the basis of a comparison of the received measurement radiation with the emitted measurement radiation, a scatter parameter for the measurement radiation reflected, transmitted or absorbed in the cooking compartment is determined on a frequency-dependent basis. On the basis of the scatter parameter, the characteristic variable for the carrier for food to be cooked is ascertained.

EP 2 019 265 A1 discloses a microwave appliance with a temperature detector for contactlessly acquiring a temperature of a foodstuff in the heating chamber, a high-frequency generator for generating a microwave for heating the foodstuff within the heating chamber and a controller for controlling the high-frequency generator based on a measurement value of the temperature detector. The controller is configured in such a way that, when a user sets any given treatment time and starts a cooking procedure, an output level of the high-frequency generator is controlled such that the temperature measured by the temperature detector does not exceed a predetermined value. Thus, resin parts and ceramic parts in the heating chamber are protected from melting.

It is the object of the present invention to overcome the disadvantages of the prior art, at least in part, and, in particular, to provide an improved possibility for heating foodstuffs by means of microwave radiation.

This object is achieved in accordance with the features of the independent claims. Advantageous embodiments are the subject matter of the dependent claims, the description and the drawings.

The object is achieved by a microwave appliance, having
a microwave facility, which is configured for generating microwaves and for introducing the microwaves into a cooking compartment and which can be operated with at least two configurations which generate different field distributions of the microwaves in the cooking compartment,
a temperature acquisition facility, which is configured for contactlessly acquiring a heat distribution in the cooking compartment,
a data processing facility, which is configured for identifying a non-food to be cooked region in the cooking compartment from the acquired heat distribution and
a control facility, which is configured for setting a current configuration of the microwave facility and for controlling the microwave facility and the temperature acquisition facility,
   wherein
the control facility is configured to select or set at least one configuration of the microwave facility with regard to reducing a power of the microwaves in the identified non-food to be cooked region.

This microwave appliance produces the advantage that it is able to determine the non-food to be cooked region in a reliable manner with structurally simple means, in particular also without using a camera that is sensitive in the visible spectral range, and consequently is able to keep an introduction of microwave power into the non-food to be cooked region low. In turn, this means that it is possible to avoid damage to accessory parts situated in the non-food to be cooked region. This is because, without monitoring the introduction of microwaves into the non-food to be cooked areas, an unfavorable microwave field distribution may occur in the cooking compartment unnoticed, which may lead to pronounced heating (at certain points) of the spatial regions not occupied by food to be cooked and, as a result, to damage to the cooking appliance. By contrast, by monitoring the temperature of the non-food to be cooked region, the overheating of said components or parts is prevented and thus consequential damage to components or even users is avoided, e.g. melting of plastic parts, surface damage due to spark discharge, burns due to touching hot parts, etc. The spark discharges may occur, for example, between accessory parts and between the cooking compartment wall and accessory parts, and may damage e.g. the enamel coating thereof, resulting in cases of melting and fusing. Components of the non-food to be cooked region may be understood in the following as meaning a wall of the cooking compartment and add-on parts in the cooking compartment, such as hot air guide plate, heating element and support structures for accessories and/or accessory (parts) such as baking sheets, oven shelves, shelf support rails, containers for food to be cooked etc.

The microwave appliance likewise advantageously enables a more rapid and especially energy-saving microwave operation: configurations which are associated with an undesirable heating of the components of the non-food to be cooked region are removed from the heating procedure, meaning that the food to be cooked is heated in a targeted manner and with improved efficiency, and the heating process can be concluded more rapidly.

The configuration is therefore advantageously chosen such that an application of microwaves in the non-food to be cooked region, in particular in or on components of the non-food to be cooked region, takes place to the lowest possible extent.

The fact that the control facility is configured to select or set at least one configuration of the microwave facility with regard to reducing a power of the microwaves in the identified non-food to be cooked region can in particular comprise the control facility being configured to set or select a configuration at the microwave facility which reduces or is intended to reduce a power of the microwaves in the identified non-food to be cooked region.

The control facility can in particular be configured to set at least one configuration of the microwave facility as a function of the identified non-food to be cooked region such that regions where the microwaves have a particularly high field strength (known as “hot spots”) in the non-food to be cooked region are, or are intended to be, suppressed or avoided. This is particularly advantageous, as such hot spots in the non-food to be cooked region waste a particularly large amount of energy and may lead to particularly severe damages.

The microwave appliance can be a stand-alone microwave appliance or additionally can have at least one thermal radiation heating element (e.g. a bottom heating element, a top heating element, a grill heating element and/or a hot air heating element for circulated hot air). For example, the microwave appliance can be an oven with microwave functionality, or can be a tabletop microwave appliance with additional oven functions. The microwave appliance is in particular a household appliance, specifically a kitchen appliance.

The microwave facility can have at least one microwave generator (e.g. a magnetron or a semiconductor-based microwave generator) for the generation of microwaves. The microwave facility can also have a microwave introduction facility for introducing the generated microwaves. The microwave introduction facility can have, for example, at least one microwave guide, at least one antenna (in particular an antenna which can be adjusted with regard to its position or orientation, e.g. a rotary antenna), at least one wobbler etc.

The fact that the microwave facility can be operated with at least two configurations which generate different field distributions of the microwaves in the cooking compartment in particular comprises at least one setting parameter at the microwave facility being able to be set to one value from a set of at least two values in each case. In one embodiment, the configuration therefore comprises at least one setting parameter with a plurality of setting values in each case.

In one embodiment, the at least one setting parameter comprises at least one setting parameter from the group consisting of
phase of the microwaves,
frequency of the microwaves,
power of the microwaves,
orientation of a movable antenna,
orientation of a wobbler,
rotational speed of a movable antenna,
rotational speed of a wobbler.

This embodiment advantageously makes it possible to change the field distribution in a particularly simple manner. For example, a rotational or angular position of a rotary antenna and/or a wobbler of the microwave introduction facility can be set in a targeted manner, in order to change a field distribution of the microwaves in the cooking compartment.

In one development, the form of the field distributions is known, in particular stored, for a plurality of, in particular all the configurations of the microwave facility, and only at least one configuration is selected which knows that it does not have a high power, in particular does not have a hot spot, in the identified non-food to be cooked region. In this context, it is also possible to choose a plurality of configurations, in succession—in particular in a cyclically alternating manner, which do not have a high power, in particular do not have a hot spot, in the identified non-food to be cooked region, but have different field distributions, in particular hot spots, in the previously identified region of the food to be cooked. This advantageously results in a particularly well distributed heating in the food to be cooked due to microwaves.

In one development, the microwave appliance, in particular the control facility thereof, is configured to select the configurations randomly. This results in the advantage that, by trial and error, particularly advantageous field distributions can be set, which cannot or cannot reliably be preset or predicted, for example due to the presence of accessories and/or food to be cooked in the cooking compartment.

In one development, the microwave appliance is configured to select a configuration randomly and subsequently to record at least one heat distribution, in order to assess the effect of the field distribution of the microwaves associated with the configuration. If the field distribution associated with the current configuration brings about a higher introduction of power into the non-food to be cooked region by microwaves than a previous configuration, then the previous configuration can be set once again, or a new configuration can be set. A higher introduction of energy or power into the non-food to be cooked region, in particular with the generation of at least one hot spot, can for example be identified at a noticeable local temperature increase. In general, regions with high field strength in the non-food to be cooked region can therefore be avoided by varying the field distribution and subsequently selecting particularly suitable field distributions, which do not have noticeable heating in the non-food to be cooked region or outside the food to be cooked. At the same time, an unnecessary input of energy into components of the non-food to be cooked region and damage to the components of the cooking compartment are therefore avoided. One desired side effect of this procedure is that the input of energy into the cooking compartment is optimized automatically, as all field distributions with hot spots outside the food to be cooked are suppressed.

In one possible development, configurations which lead to an undesired heating in the non-food to be cooked region are saved and are no longer used for the further heating procedure. This results in a reduced selection of possible parameter sets, which in particular can be used in an alternating manner for uniform heating of the food to be cooked.

To change a configuration—where possible—one or more setting parameters can be changed.

The temperature acquisition facility (which can also be referred to as IR detection facility) can have one or more temperature sensors. The at least one temperature sensor can comprise at least one thermal imaging camera, for example. The temperature acquisition can take place, for example, on a two-dimensional basis from a fixed viewing position of a temperature sensor or on a three-dimensional basis by way of a stereographic recording technique. In general, the temperature distribution can be present as a one, two or three-dimensional temperature image (which can also be referred to as an IR image).

In another development, the temperature sensor is a sensor with low resolution (e.g. an IR photodiode or a thermopile), the image thereof being improved by superimposing a plurality of recordings from various positions of the temperature sensor. For example, in one development, a movable temperature sensor with precisely one IR-sensitive cell (e.g. an IR photodiode) is used for measurement, wherein the temperature sensor scans the entire cooking compartment by way of variable-position recording, and thus creates a multidimensional image. The use of a plurality of sensors at different positions and/or movable sensors offers the advantage that the temperature distribution of the cooking compartment can be acquired in a particularly complete manner.

The data processing facility is in particular configured to differentiate between the non-food to be cooked region and the spatial region in which the food to be cooked is situated.

The data processing facility can be a discrete component or instance. It can be integrated into the microwave appliance or can also be an external instance, e.g. a network server or a cloud-based data processing facility. Alternatively, the data processing facility can be integrated into the control facility, which then comprises a data processing function for performing the method.

The control facility is used to operate or to control the microwave appliance and therefore also to control the microwave facility, specifically also by means of selecting or setting the configuration of the microwave facility.

In one embodiment, the data processing facility is configured to identify the non-food to be cooked region on the basis of its temperature level or a temperature level of its components. The non-food to be cooked region can therefore be determined in an advantageously simple manner. In this context, use is made of the fact that components of the non-food to be cooked region typically heat up more quickly than food to be cooked. This applies in particular if the components consist of metal or feature metal. Particularly when the cooking compartment has not yet reached its temperature equilibrium (e.g. while heating up), the components of the non-food to be cooked region typically have a higher temperature than food to be cooked, and the non-food to be cooked region can consequently be identified or recognized on the basis of the temperature level of the components contained therein. This identification can be performed, for example, by means of an identification of regions (in particular image regions in a temperature image) which exceed a predefined absolute or relative temperature threshold value. The temperature level can correspond to a predefined fixed or variable temperature threshold value (e.g. a set target cooking compartment temperature and/or the time which has elapsed since the beginning of the treatment of the food to be cooked).

In one alternative or additional embodiment, the data processing facility is configured to identify the non-food to be cooked region as opposed to food to be cooked on the basis of a temperature change taking place at a different speed. In this context, use is also made of the fact that components of the non-food to be cooked region typically heat up more quickly than food to be cooked, which generally has a higher thermal capacity. Instead of evaluating at a predefined temperature level, however, the heating speed (also referred to as heating rate) is now used as a criterion for association with the non-food to be cooked region: the faster a material volume heats up, the higher the probability that it does not involve food to be cooked. Areas with a strong temperature rise can therefore be classified as accessories or a non-food to be cooked region of the cooking compartment. In order to determine the heating speed, the temperature distributions of two or more heat distributions can be compared with one another.

In one development, the configuration is set in a targeted manner, such that no hot spots occur on an accessory part. Hot spots may possibly continue to occur in an air-filled spatial region of the cooking compartment, but these are less critical with regard to damage (overheating, sparking, etc.) to the microwave appliance.

In one embodiment, the data processing facility is configured to identify at least one type of a component, in particular an accessory part, of the non-food to be cooked region situated in the cooking compartment on the basis of its heating curve. This means that components, in particular accessory parts, of the non-food to be cooked region can be identified in the thermal image in an even more precise manner, whereby the configuration of the microwave generation facility can be adapted towards avoiding critical hot spots in an even more targeted manner.

Such a qualitative identification of accessory parts of the non-food to be cooked region can be achieved by matching against characteristic forms in the temperature distribution, which can also be considered as “object identification in the infrared range”. For example, in the temperature distribution, it is possible to identify bands which correspond to the grating bars of an oven shelf, and as a result it is possible to infer a presence of an oven shelf, the insertion height thereof and a position of food to be cooked placed thereon. For example, with a different spacing between the oven shelf and the temperature acquisition facility in the temperature distribution, other spacings between the corresponding bands in the temperature distribution are produced, from which in turn it is possible to infer an insertion height. Instead of or in addition to the bands defined by the grating bars of the oven shelf in the temperature distribution, in the presence of a baking sheet, it is possible to evaluate a position and/or length of the edges, etc. Such an identification of the various accessory parts advantageously also helps in preventing incorrect operation such as using a baking sheet during pure microwave operation. Moreover, a mode of operation can be adapted to the accessory used.

In one embodiment, the data processing facility is configured to identify the non-food to be cooked region by a presence of markers. Thus, the non-food to be cooked region can be determined in a particularly precise manner, specifically for a large number of different accessory parts. The markers are special identification marks, which can be identified as geometric identification features in the acquired heat distribution. For this purpose, the markers are arranged on corresponding components of the non-food to be cooked region (e.g. on a cooking compartment wall, on accessory parts, etc.), in particular at known points. In one development, the markers identify a component, i.e. are used as an identification or ID for the component, in particular an accessory part.

In one development, a marker is embodied as a shaped area, punched hole, texture and/or roughened area. In particular, a texture or roughened area may be apparent in a defined manner via different emissivities in the heat distribution. Likewise, a marker can be embodied as a region with materials having different thermal capacities or emissivities, so that a defined pattern can be identified in the heat distribution when it is heated.

In one embodiment, the data processing facility is configured to determine the non-food to be cooked region during a heating-up phase of the cooking compartment. This is particularly advantageous, as a temperature equilibrium has not yet been reached in the cooking compartment and it is therefore possible to identify temperature differences between materials having different thermal capacities (e.g. food to be cooked and components of the non-food to be cooked region) in a particularly reliable manner.

In one development, the heating-up phase is part of a normal heating process and therefore is not a specifically set phase.

In one development, the heating-up phase is a specifically set phase. The heating-up procedure can therefore be defined in a particularly reliable manner, which facilitates identification of the components of the non-food to be cooked region.

In one embodiment, the microwave appliance additionally has at least one thermal radiation heating element and the control facility is configured to activate (only) the at least one thermal radiation heating element during the heating-up phase. As a result, a particularly uniform heating-up of the cooking compartment is advantageously achieved, which enables a particularly reliable identification of the components of the non-food to be cooked region.

In one development, the heating-up phase is provided as a preheating phase, during which there is not yet any food to be cooked in the cooking compartment. This enables a particularly reliable and accurate determination of the components of the cooking compartment. A determination of the non-food to be cooked region can then take place, for example, by way of an image comparison of a heat distribution during or after the termination of the preheating phase and a heat distribution after the introduction of the food to be cooked (in a “cooking phase”). This is a particularly advantageous if a heat distribution is recorded in a brief temporal interval after introducing the food to be cooked, as the food to be cooked is then still comparatively cold and therefore stands out considerably from a thermal perspective compared to the non-food to be cooked region. The recording of the heat distribution during the cooking phase can be performed, for example, automatically after identifying a door opening procedure and subsequent door closing procedure during or after the termination of the preheating phase. Noticeable deviations between the two temperature distributions can be interpreted as an indication of a presence of food to be cooked at those locations.

In one development, in order to identify components, in particular accessories, of the non-food to be cooked region, a temperature development of the unloaded cooking compartment during preheating can be compared with previously recorded comparison curves, which have been recorded with various accessory parts, in order to therefore infer the type of accessory part used.

The method above can also be used if a cooking compartment door is opened during a cooking procedure and the food to be cooked is moved (stirring/turning) or briefly removed. In said contexts, the accessory cools down more rapidly than the food to be cooked due to the different thermal capacities. For the identification of the non-food to be cooked region (which can change after the food to be cooked is removed and reinserted), the temperature difference which has now arisen due to the cooling down and/or the different heating rate can be used when heating up again.

The object is also achieved by a method for operating a microwave appliance, in which
a cooking compartment of the microwave appliance is heated up,
a heat distribution in the cooking compartment is acquired in a contactless manner,
a non-food to be cooked region in the cooking compartment is determined from the heat distribution and
a field distribution of microwaves in the cooking compartment is set such that regions with high field strength in the non-food to be cooked region are avoided.

The method may be embodied in an analogous manner to the microwave appliance and has the same advantages.

In one embodiment, the method is performed in an iterative manner. In particular, for this purpose, the non-food to be cooked region can be monitored by temporally successive recordings of heat distributions during a heating process and, if necessary as a result of the monitoring, new configurations can be set which introduce a lower power into the non-food to be cooked region, in particular as described above. It is therefore possible for iterative configurations, which produce regions with high field strength in the non-food to be cooked region, to be selected for a subsequent operation.

The above-described properties, features and advantages of this invention and the manner in which these are achieved will become clearer and more readily understandable in connection with the following schematic description of an exemplary embodiment, which will be described in further detail making reference to the drawings.

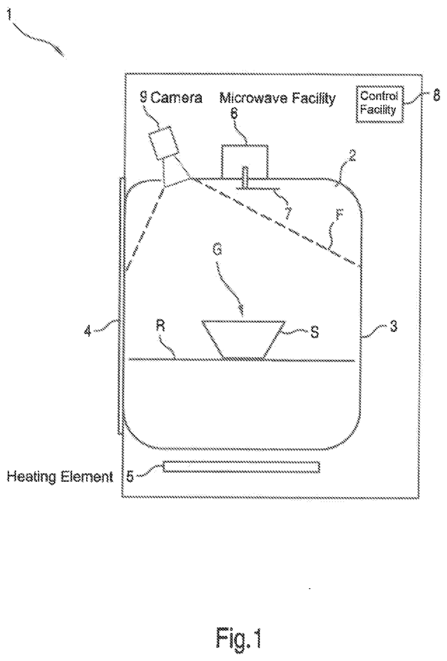

FIG. 1 shows a sectional representation in a side view of a household cooking appliance in the form of an oven with a microwave facility and

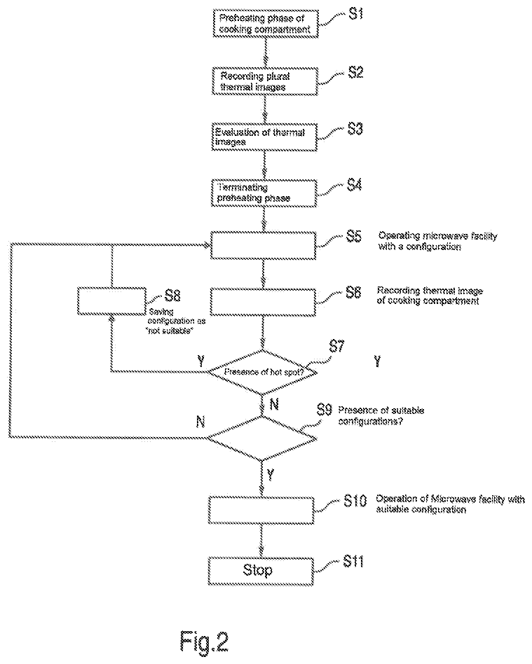

FIG. 2 shows procedure steps of a possible method for setting a configuration of the microwave facility.

FIG. 1 shows a household cooking appliance in the form of an oven 1 with integrated microwave functionality. The oven 1 has a cooking compartment 2, which is delimited by a cooking compartment wall 3, the front loading opening of which being able to be closed by means of a cooking compartment door 4 which is impermeable to microwaves and thermally insulated.

To heat food to be cooked G situated in the cooking compartment 2, it can be heated by means of at least one thermal radiation heating element (e.g. a bottom heating element, top heating element, grill heating element and/or hot air heating element, indicated here by a bottom heating element 5).

The oven 1 furthermore has a microwave facility 6 with a rotary antenna 7 which is able to rotate. By way of the rotary antenna 7, it is possible for microwaves generated by the microwave facility 6 to be introduced into the cooking compartment 2, wherein they assume a particular microwave field distribution or field pattern. The operation of the thermal radiation heating element 5 and the microwave facility 6, including a rotational position or a rotational angle of the rotary antenna 7 which is able to rotate in a horizontal plane, can be set in a targeted manner via a control facility 8. For example, the rotational position of the rotary antenna 7 can be set in steps of 1°, 5°, 10° or the like.

The oven 1 additionally has a temperature acquisition facility for the contactless acquisition of a heat distribution in the cooking compartment 2 in the form of a thermal imaging camera 9 which measures in pixels. The food to be cooked G, which is accommodated in a container for food to be cooked S, which in turn rests on an accessory in the form of an oven shelf R or the like, is situated in a field of view F of the thermal imaging camera 9, as is the accessory.

The control facility 8 is used to control the oven 1 and is also used to evaluate the heat distributions or thermal images ascertained by the thermal imaging camera 9. The thermal images are constructed in a pixel-like manner and have a resolution of 16×16, 32×24, 64×64, 128×64, 256×256, 512×512 or 2048×2048 pixels, for example, but are not restricted thereto. The control facility 8 is further used as a data processing facility for evaluating the thermal images, in particular for identifying a non-food to be cooked region in the cooking compartment 2 in at least one thermal image.

FIG. 2 shows procedure steps of a possible method for operating the oven 1, in particular for setting a configuration of the microwave facility 6, 7.

In step S1, a preheating phase of the oven is activated, wherein the cooking compartment 2 is only heated by the at least one thermal radiation heating element 5. The microwave facility 6, 7 remains deactivated during the preheating phase.

In step S2, the thermal imaging camera 9 is used to record a plurality of thermal images at sufficient temporal intervals.

In step S3, the thermal images are evaluated by the control facility 8 in that different absolute temperatures and/or heating rates of different regions in the thermal images are identified and regions with particularly high temperatures and/or heating rates are assigned to an accessory, e.g. the oven shelf R. The oven shelf R can be identified by a grid pattern that appears bright in the thermal images, for example. This can be confirmed by a typical heating progression for the oven shelf R.

In step S4, when the preheating phase is terminated—possibly with the deactivation of the at least one thermal radiation heating element 5—the cooking compartment door 4 is opened, the food to be cooked G is introduced into the cooking compartment 2 and the cooking compartment door 4 is then closed again. This opening and closing of the cooking compartment door 4 is identified automatically.

Subsequently, the control facility 8 actuates the thermal imaging camera 9 in order to record a thermal image of the cooking compartment 2 and to compare this thermal image with at least one thermal image recorded in step S3. By evaluating differences in the thermal images, the food to be cooked G (in the form of a colder region left out of the regular grid pattern from the perspective of the thermal imaging camera 9) and the non-food to be cooked region 3, 4, R are identified.

Subsequently, in step S5, the microwave facility 6, 7 is operated in a particular configuration. In this context, a setting parameter of the configuration can correspond to a rotational position of the rotary antenna 7.

In one variant, the microwave facility 6, 7 is only activated with a configuration which knows that it does not generate hot spots in the non-food to be cooked region. In another variant, the microwave facility 6, 7 is activated successively with different configurations, which e.g. correspond to different rotational positions of the rotary antenna 7, which know that they all do not generate hot spots in the non-food to be cooked region. This enables a particularly uniform heating of the food to be cooked G. This can be continued until the end of the cooking phase or the treatment procedure.

In another variant, in step S5, a randomly chosen configuration of the microwave facility 6, 7 is set and it is operated with said configuration.

Subsequently, in step S6 a thermal image of the cooking compartment 2 is recorded and in step S7 it is examined whether a noticeable local temperature increase occurs in the previously identified or determined non-food to be cooked region, which may in particular indicate a hot spot, e.g. in the region of the oven shelf R and/or in the region of a cooking compartment wall 3.

If this is the case (“Y”), then in step S8 the currently set configuration is saved as “not suitable” and the method branches back to step S5, where another configuration for the microwave facility 6, 7 is randomly set.

If this is not the case (“N”), then the current configuration can be retained in one variant for the rest of the cooking procedure or treatment procedure. Alternatively, the currently set configuration can be saved as “suitable” and it can then be examined in step S9 whether a predefined number (e.g. two, three, four or more) of suitable configurations have already been found.

If this is not the case (“N”), then it is possible to branch back to step S5 and set a further randomly chosen configuration at the microwave facility 6, 7.

If this is the case (“Y”), then the microwave facility 6, 7 can then in step S10 only be operated with the suitable configurations in an alternating manner.

The method described above is performed until, in step S11, a stopping criterion has been reached, e.g. a period of time specified on the user side or program side has expired.

The present invention is of course not restricted to the exemplary embodiment shown.

In general, “a”, “an”, etc. can be understood as singular or plural, in particular in the sense of “at least one” or “one or more”, etc., provided this is not explicitly excluded, e.g. by the expression “precisely one”, etc.

A numerical value can also include the given value as well as a typical tolerance range, provided this is not explicitly excluded.

### LIST OF REFERENCE CHARACTERS

1 Oven
2 Cooking compartment
3 Cooking compartment wall
4 Cooking compartment door
5 Thermal radiation heating element
6 Microwave facility
7 Rotary antenna
8 Control facility
9 Thermal imaging camera
F Field of view
G Food to be cooked
R Oven shelf
S Container for food to be cooked
S1-S11 Method steps

1-12. (canceled)

13. A microwave appliance, comprising:
a microwave facility configured to generate microwaves and introduce the microwaves into a cooking compartment, said microwave facility operable with at least two configurations to generate different field distributions of the microwaves in the cooking compartment;
a temperature acquisition facility configured to contactlessly acquire a heat distribution in the cooking compartment,
a data processing facility configured to identify a non-food to be cooked region in the cooking compartment from the acquired heat distribution; and
a control facility configured to set a current configuration of the microwave facility and to operate the microwave facility, said control facility configured to select or set at least one of the configurations of the microwave facility with regard to reducing a power of the microwaves in the identified non-food to be cooked region.

14. The microwave appliance of claim 13, wherein the data processing facility is configured to identify the non-food to be cooked region based on a temperature level thereof.

15. The microwave appliance of claim 13, wherein the data processing facility is configured to identify the non-food to be cooked region based on a temperature difference between components of the non-food to be cooked region and a food to be cooked.

16. The microwave appliance of claim 13, wherein the data processing facility is configured to identify the non-food to be cooked region based on a different speed of a temperature change between components of the non-food to be cooked region and a food to be cooked.

17. The microwave appliance of claim 13, wherein the data processing facility is configured to identify a type of a component of the non-food to be cooked region situated in the cooking compartment based on a heating curve thereof.

18. The microwave appliance of claim 13, wherein the data processing facility is configured to identify a component of the non-food to be cooked region by a presence of a marker arranged on the component.

19. The microwave appliance of claim 13, wherein the data processing facility is configured to determine the non-food to be cooked region during a heating-up phase.

20. The microwave appliance of claim 13, further comprising a thermal radiation heating element, said control facility configured to activate the thermal radiation heating element during a heating-up phase.

21. The microwave appliance of claim 13, further comprising a thermal radiation heating element, said control facility configured to activate the thermal radiation heating element during a preheating phase.

22. The microwave appliance of claim 13, wherein each of the configurations comprises a setting parameter with a plurality of setting values.

23. The microwave appliance of claim 22, wherein the setting parameter is selected from the group consisting of phase of the microwaves, frequency of the microwaves, power of the microwaves, orientation of a movable antenna and/or a wobbler, and rotational speed of a movable antenna and/or a wobbler.

24. A method for operating a microwave appliance, said method comprising the steps of:
a) heating up a cooking compartment of the microwave appliance;
b) acquiring a heat distribution in the cooking compartment in a contactless manner;
c) determining a non-food to be cooked region in the cooking compartment from the heat distribution; and
d) setting a field distribution of microwaves in the cooking compartment such that a region with high field strength in the non-food to be cooked region is avoided.

25. The method of claim 24, further comprising:
iterating the steps a) to d);
varying the field distribution of microwaves in the cooking compartment to provide plural field distributions; and
subsequently selecting a field distribution of the plural field distributions sufficient to avoid the region with high field strength in the non-food to be cooked region.
